(19) United States
(12) Patent Application Publication
(10) Pub. No.: US 2013/0266751 A1
(43) Pub. Date: Oct. 10, 2013

(54) TUBE LAMINATE FILM HAVING AT LEAST ONE ORIENTED BARRIER LAYER AND TUBE PACKAGING FORMED AT LEAST PARTIALLY FROM SAID TUBE LAMINATE FILM

(71) Applicants: Arnold Schneider, Kempten (DE); Manfred Marz, Kempten (DE); Arno Holzmuller, Kempten (DE)

(72) Inventors: Arnold Schneider, Kempten (DE); Manfred Marz, Kempten (DE); Arno Holzmuller, Kempten (DE)

(73) Assignee: HUHTAMAKI FLEXIBLE PACKAGING GERMANY GMBH & CO. KG, Ronsberg/Allgau (DE)

(21) Appl. No.: 13/878,941

(22) PCT Filed: Oct. 12, 2011
(86) PCT No.: PCT/EP11/67769

§ 371 Date: Jun. 10, 2013

(30) Foreign Application Priority Data
Oct. 12, 2010 (DE) 10 2010 042 342.4

(51) Int. Cl. B32B 1/08

(52) U.S. Cl. CPC B32B 1/08
USPC 428/35.7

(57) ABSTRACT

Tube laminate film (22) for the production of a tube packaging having at least one plastics layer (36, 38) and also at least one barrier layer (30) is characterised in that the barrier layer (30) is an oriented barrier layer (30).

The invention relates to a tube laminate film for the production of a tube packaging. The tube laminate film comprises at least one plastics layer and also comprises at least one barrier layer.

Tube laminate films of this type are well known from the prior art.

Tube packagings, for example for the packaging of toiletries, such as toothpaste, or also for the packaging of foodstuffs, are usually formed from a tubular tube body and a closure component joined therewith. The above-mentioned tube laminate films are usually used to produce the tubular tube body.

The above-mentioned at least one plastics layer, which does not have a barrier characteristic, usually provides the necessary stability of the packaging formed from the film and furthermore generally allows printing thereon or allows other external designs.

The at least one barrier layer is provided to protect the content of the packaging from external environmental influences, in particular from oxygen and water vapour which can cause an undesirably rapid deterioration or an undesirably rapid spoiling of the packaging content. The barrier layer is also used to prevent components of the packaging content (aromas, water vapour, etc.) from being able to escape from the packaging, which is undesirable.

The object of the present invention is to further improve the known tube laminate film.

Starting from a tube laminate film mentioned at the outset, this object is achieved in that the barrier layer is an oriented barrier layer which has a molecular directional orientation.

A molecular directional orientation of this type can be achieved, for example, by stretching the barrier layer.

It has surprisingly been found that a stretched or oriented barrier layer has a stronger barrier effect than a non-oriented barrier layer of the same thickness. In this respect, an indication of the barrier effect of a barrier layer is the permeability of this layer to oxygen.

Thus, by providing an oriented barrier layer, it is possible to produce a tube laminate film which has the same barrier effect as a thinner tube laminate film, known from the prior art, or to provide a tube laminate film of the same thickness with an improved barrier effect.

In this respect, the barrier layer can be stretched mono-axially, i.e. it can be directionally oriented in a single spatial direction. An even greater increase in the barrier effect can be achieved by a biaxial orientation of the at least one barrier layer, i.e. by orienting the barrier layer in two spatial directions which mutually enclose an angle, preferably orthogonally.

To achieve the best possible barrier effect as well as a join, which is as simple as possible to produce, of the barrier layer of the tube laminate film to further layers of the laminate film, it is advantageous if the oriented barrier layer is part of an oriented sub-laminate packet in the tube laminate film. This means that a sub-laminate packet can be produced separately from the tube laminate film and is prepared and equipped for further lamination with further plastics layers or other functional layers.

Basically, the sub-laminate packet can comprise a plurality of barrier layers, of which at least one, preferably a plurality, particularly preferably all, has/have an orientation. This orientation can be a mono-axial orientation or, to produce an increased barrier effect, it can be a biaxial orientation.

Furthermore, the sub-laminate packet, as an asymmetrical sub-laminate packet, can have precisely one outer plastics layer of the sub-laminate packet, while a further outer layer of the sub-laminate packet is formed by a barrier layer.

The outer plastics layer can be selected such that it can be securely joined to the at least one plastics layer of the tube packaging in a particularly simple manner.

This sub-laminate packet can comprise, for example, a first outer plastics layer, a second outer plastics layer, and a barrier layer provided between these outer plastics layers.

For example, the outer plastics layers can be selected such that they can be joined particularly advantageously to the at least one further plastics layer of the tube laminate film.

Within the sub-laminate packet, suitable adhesion promoting layers can ensure an optimal join between the at least one barrier layer and the outer plastics layers of the sub-laminate packet.

At least one of the outer plastics layers of the sub-laminate packet can be formed from a polyolefin, polyamide, PLA or polyester. Preferred as polyolefins are polyethylene or polypropylene which can be laminated particularly effectively with further layers due to their thermoplastic characteristics. An outer plastics layer selected from polyester is preferably also formed from a thermoplastic polyester, such as polyethylene terephthalate, to increase the joining ability of the outer plastics layer to further plastics layers.

At least one, but preferably each of the outer plastics layers is configured as a sealing layer.

As already stated above, the sub-laminate packet can be integrated into the tube laminate film as a prefabricated laminate arrangement, which simplifies the lamination of the at least one barrier layer with further plastics layers of the sub-laminate packet. On account of the materials which are usually used for the barrier layer, adhesion promoting layers, for example copolymers, may sometimes be necessary, interposed between a plurality of barrier layers or positioned between a barrier layer and an adjacent plastics layer.

After it has been produced, the entire sub-laminate packet is preferably directionally oriented as a unit, so that not only the barrier layers provided therein, but also the outer plastics layers and, if appropriate, further plastics layers preferably have one directional orientation, preferably the same directional orientation.

To further increase the barrier effect, the tube laminate film can comprise a plurality of barrier layers. This applies in particular to the sub-laminate packet which combines, advantageously all, barrier layers, to simplify the handling of the individual tube laminate film components. If a plurality of barrier layers is present, a particularly good lamination is achieved by providing between two adjacent barrier layers an adhesion promoting layer which can advantageously comprise a compatible copolymer.

In principle, any number of barrier layers of a sub-laminate packet can be provided. From a production point of view, a sub-laminate packet preferably comprises a number, which is a power of two, i.e. 1, 2, 4, 8, 16, 32 and the like, of barrier layers. In this respect, it is obvious that the barrier effect of the sub-laminate packet increases with an increasing number of barrier layers.

The tube laminate film can be produced quickly, and thus advantageously, if the tube laminate film, in particular the sub-laminate packet, is produced as a so-called “one-shot barrier”. In this respect, a plurality of barrier layers, generally three barrier layers with adhesion promoting layers arranged in between in each case, are usually extruded in one co-extrusion step as laminate. This one-shot barrier is preferably oriented in its entirety, for example by stretching.

Furthermore, to increase its barrier effect, the tube laminate film can also comprise a plurality of sub-laminate packets which are joined together. Two sub-laminate packets are preferably joined together by arranging an adhesion promoting layer between them. In this respect, polyolefin has proved to be an economical but efficient material as the adhesive material.

The plurality of sub-laminate packets can be a mixture of different types of sub-laminate packets, for example one sub-laminate packet which, apart from adhesion promoting layers which may be provided, only comprises barrier layers, and/or another sub-laminate packet which comprises one or more plastics layers, for example a previously mentioned asymmetric sub-laminate packet or a sub-laminate packet in which at least one barrier layer is provided between two plastics layers.

The barrier layer can preferably comprise ethylene vinyl alcohol, abbreviated to EVOH, AlᵥOₓ, i.e. aluminium oxide, and/or SiO_{y}, i.e. silicon oxide. v, x and y are integers.

Within a layer, a metal oxide can be present in different oxidation stages, for example as AlO and Al₂O₃ or as SiO and SiO₂.

Furthermore, the barrier layer can comprise a metallised plastics layer, for example metallised polyethylene terephthalate, metallised polylactic acid (PLA) or metallised oriented polyamide.

Likewise, the barrier layer can comprise non-metallised polylactic acid (PLA).

With regard to the definition of a barrier layer in the context of the present application, the following should be noted:

If a laminate film or a sub-laminate packet comprises a layer of EVOH and/or AlᵥOₓ and/or SiO_{y}, layers of the mentioned materials, irrespective of their thickness, are to be considered as a barrier layer within the context of the present application.

If a laminate film or a sub-laminate packet contains a film of polyamide and/or polyethylene terephthalate, said film is a barrier layer in the context of the present application if this layer has the lowest oxygen permeability of all layers present in the considered laminate or, if further layers having an oxygen barrier effect are present, this layer has an oxygen barrier effect which exceeds that of the other laminate films taken together by not more than a factor of 10.

Within the context of the present application, tube film laminates and sub-laminate packets which only comprise polyolefin layers are considered as being free from an oxygen barrier.

In this respect, the oxygen barrier effect is to be considered as the volume of oxygen, which has passed through the respective layer, per partial pressure difference of oxygen, surface area and time, i.e. for example:

$$\frac{cm 3}{bar \cdot m 2 \cdot d} .$$

Lower numerical values of the oxygen barrier effect determined thus exhibit a better oxygen barrier effect than higher numerical values.

The at least one plastics layer mentioned at the outset can be any suitable plastics layer, for example a polyolefin layer, in particular an oriented polyolefin layer, such as oriented polypropylene, particularly preferably biaxially oriented polypropylene.

Likewise, the above-mentioned PLA can be used as a preferred biologically degradable plastics material for the formation of the at least one plastics layer.

The tube laminate film according to the invention preferably has a structure in which two plastics layers are provided, between which the barrier layer or the sub-laminate packet described above is arranged. The two plastics layers are preferably outer layers of the tube laminate film.

Furthermore, to achieve a structure which is as symmetrical as possible, it is preferred that the two plastics layers with the at least one barrier layer or the sub-laminate packet arranged between them are produced from the same plastics material, although this is not absolutely necessary.

At least one, but particularly preferably each, of the outer plastics layers of the tube laminate film is preferably a sealable layer, i.e. for example a layer of a thermoplastic polymer.

Furthermore, one or more plastics layers outside the sub-laminate packet can also be provided with a metal coating.

In addition, independent protection is claimed for a tube packaging with a tubular tube body and a closure component joined thereto, in which tube packaging at least the tube body is formed at least partly, preferably completely from a tube laminate film, as described above.

In order to be able to provide the tube formed from the tube laminate film described above with the necessary dimensional stability and strength, it is preferred that the tube laminate film has a thickness of more than 100 μm, preferably more than 150 μm, particularly preferably of between 200 and 300 μm. However, the thickness required for dimensional stability and strength can vary, depending on the film laminate materials which are used.

In the following, the present invention will be described in more detail with reference to the accompanying figures which illustrate an embodiment according to the invention of a tube laminate film.

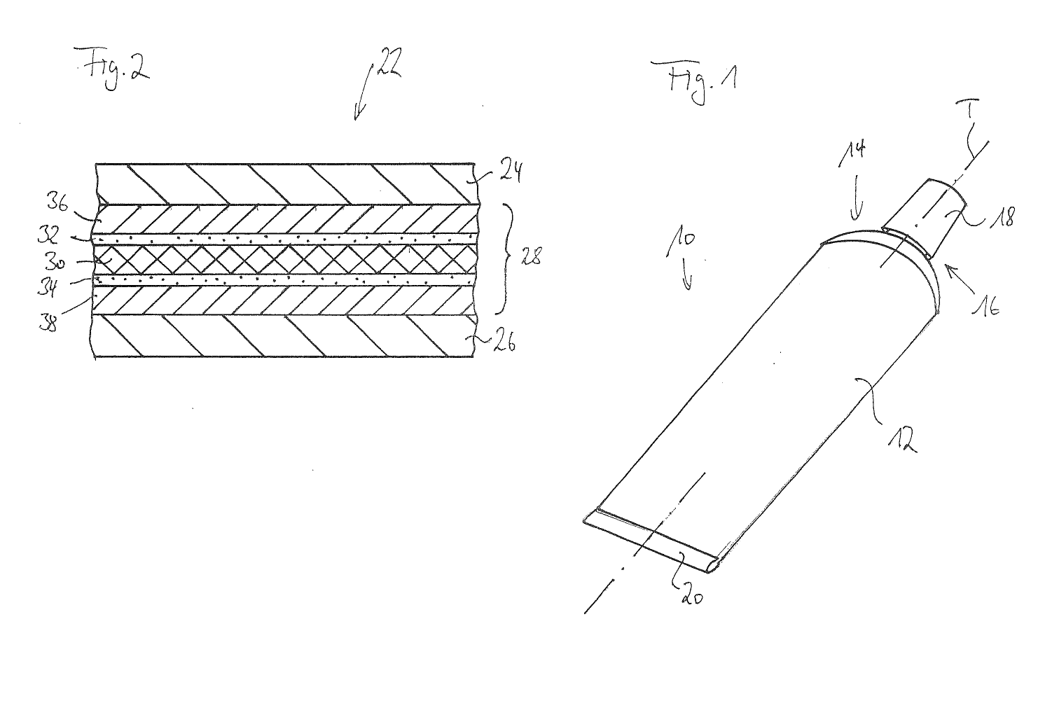

FIG. 1 is a perspective view of a tube packaging.

FIG. 2 shows a cross section through an embodiment according to the invention of a tube laminate film which can be used to produce the tube body of the tube packaging of FIG. 1.

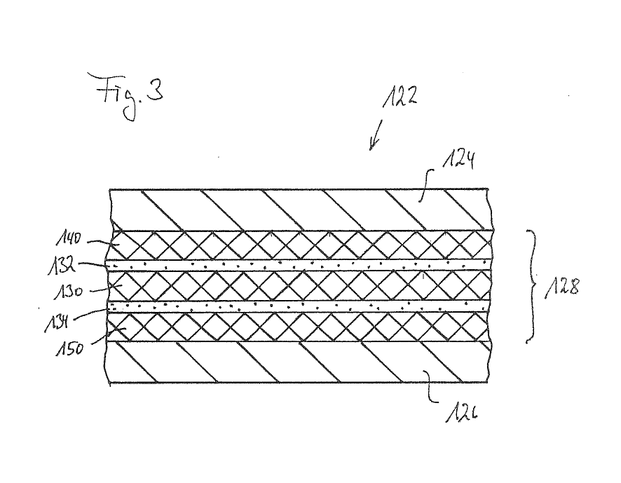

FIG. 3 shows a further embodiment of a tube laminate film according to the invention.

In FIG. 1, a tube packaging is generally denoted by reference numeral 10. The tube packaging comprises a substantially tubular tube body 12 which joins a closure component 14 at one longitudinal end. The closure component 14 can comprise, for example, a screw closure 16 with an unscrewable cap 18. At its longitudinal end remote from the junction with the closure component 14, the tube body 12 is sealed by a transverse sealing seam 20 which extends substantially orthogonally to the longitudinal axis T of the tube.

While the closure component 14 can be formed from injection moulded or deep-drawn plastics material to be able to provide in particular a stable thread for the screw closure 16, the tube body 12 of the tube packaging 10 is generally formed from a laminate film.

FIG. 2 is a cross-sectional view, not true to scale, of a tube laminate film 22 suitable for the production of the tube body 12. The tube laminate film 22 can comprise, for example, two outer plastics layers 24 and 26, of which at least one is produced from a thermoplastic polymer, i.e. from a sealable material, to produce the transverse sealing seam 20 and/or to join to the closure component 14.

For example, at least one of the plastics layers 24 and 26 can be formed from polypropylene, oriented polypropylene, PLA (polylactic acid) and the like. Plastics layer 24 and/or plastics layer 26 can have a metal coating, preferably on a side facing a further layer.

The tube laminate film 22 is preferably constructed with a substantially symmetrical layering which facilitates the further processing of the film, since the orientation thereof is not important. Processing errors are thus avoided.

Located between the plastics layers 24 and 26 is a layer laminate which is preferably provided as a prefabricated sub-laminate packet 28, the central layer 30 of which is formed by an oriented barrier layer, for example by a layer of EVOH.

Two thermoplastic polymer layers, in particular polyolefin layers, particularly preferably polyethylene layers 36 and 38, are joined to the central barrier layer by two adhesion promoting layers 32 and 34 on each side of the barrier layer 30 to form the sub-laminate packet 28.

The plastics layers 36 and 38 form outer layers of the sub-laminate packet 28.

In the example shown in FIG. 2, the adjacent plastics material laminate layers 24 and 36 on one hand and 26 and 38 on the other are formed from compatible plastics material, so that an adhesion promoting layer does not have to be arranged between them in order to join them together. This is the case, for example, when the plastics layers 24 and 26 are formed from oriented polypropylene (OPP) and when the outer layers 36 and 38 of the sub-laminate packet 28 are formed from polyethylene compatible therewith.

The sub-laminate packet 28 is preferably oriented in its entirety, for example by one or more stretching procedures. The outer layers 36 and 38 are thus also oriented substantially in the same way as the central barrier layer 30.

FIG. 3 shows an alternative embodiment of the tube laminate film 22 of FIG. 2. Components or component portions which are identical or functionally identical to those of FIG. 2 are provided in the embodiment of FIG. 3 with the same reference numeral, but added to 100, so that for the description thereof, reference is made fundamentally and explicitly to the description of FIG. 2.

In the following, FIG. 3 will be described only insofar as it differs from the embodiment of FIG. 2.

The sub-laminate packet 128 of the tube laminate film 122 of FIG. 3 is a so-called “one-shot barrier” which is produced in a single co-extrusion procedure. In this procedure, three barrier layers 130, 140 and 150 which are joined together by interposed adhesion promoting layers 132 and 134 are produced in a single step as a sub-laminate packet 128.

Here again, the sub-laminate packet 128 is directionally oriented in its entirety, for example by stretching.

The plastics layers 124 and 126 are preferably selected such that they can be joined to the one-shot barrier 128 without an adhesion promoting layer. For example, the plastics layers 124 and/or 126 can be formed from oriented polypropylene or from PLA or from the other plastics materials mentioned above, in each case with or without a metal coating.

Due to the molecular directional orientation of the barrier layer, in particular of the sub-laminate packet 28 and 128 comprising the barrier layer, the barrier effect of the at least one barrier layer 30 and 130, 140 and 150 can be increased such that, with the same barrier efficiency in respect of the passage of oxygen and/or water vapour through the barrier layer, the barrier layers of the tube laminate film 22 and 122 according to the invention can be thinner and thus the tube laminate film 22 and 122 can be configured overall with a lower weight compared with the prior art and with the non-oriented barrier layers known therefrom.

It should be added that adhesion promoting layers can also be provided between a sub-laminate and at least one previously mentioned outer layer 24, 26 and 124, 126 to increase the bond between sub-laminate packet and outer plastics layer.

Furthermore, a tube laminate film according to the invention can also comprise more than one sub-laminate packet.

In addition, at least one sub-laminate packet of the tube laminate film as a so-called asymmetric sub-laminate packet can have only one outer plastics layer of the sub-laminate packet which is not a barrier layer, while a further outer layer of the sub-laminate packet is formed by a barrier layer.

The examples illustrated here show tube laminate films or sub-laminate packets having one or three barrier layers. This number of barrier layers is merely an exemplary number. It may be preferred from a production point of view to provide barrier layers in a number corresponding to a power of two, i.e. for example to provide a tube laminate film having 1, 2, 4, 6, 8, 16, 32, etc. barrier layers, of which at least one, preferably a plurality, particularly preferably all, has/have a molecular orientation to increase the barrier effect thereof.

Alternatively, it is also possible, departing from the above embodiment, for the at least one outer plastics layer 24 and 26 or 124 and 126 illustrated in the above examples to be applied as a coating layer to a layer located thereunder.

According to another approach, the barrier effect of barrier layers 30 and 130, 140 and 150 can be increased with the same layer density as a result of orienting said barrier layers.

1. Tube laminate film for the production of a tube packaging having at least one plastics layer and additionally at least one barrier layer, wherein the barrier layer is an oriented barrier layer.

2. Tube laminate film according to claim 1, wherein the oriented barrier layer is part of an oriented sub-laminate packet in the tube laminate film.

3. Tube laminate film according to claim 2, wherein the sub-laminate packet as an asymmetric sub-laminate packet has precisely one outer plastics layer of the sub-laminate packet, while a barrier layer forms a further outer layer of the sub-laminate packet.

4. Tube laminate film according to claim 2, wherein the sub-laminate packet comprises a first outer plastics layer of the sub-laminate packet, a second outer plastics layer of the sub-laminate packet and a barrier layer provided between the outer plastics layers.

5. Tube laminate film according to claim 3, wherein at least one outer plastics layer is formed from polyolefin, polyamide, PLA or polyester.

6. Tube laminate film according to claim 2, wherein the sub-laminate packet is incorporated into the tube laminate film as a prefabricated laminate arrangement.

7. Tube laminate film according to claim 2, wherein the tube laminate film, in particular the sub-laminate packet, comprises a plurality of barrier layers, in a number which is a power of two.

8. Tube laminate film according to claim 7, wherein an adhesion promoting layer is provided between two adjacent barrier layers.

9. Tube laminate film according to claim 2, wherein the tube laminate film, in particular the sub-laminate packet, is produced as a one-shot barrier.

10. Tube laminate film according to claim 2, wherein the sub-laminate packet comprises a plurality of sub-laminate packets which are joined together, by an adhesion promoting layer of polyolefin.

11. Tube laminate film according to claim 1, wherein the barrier layer comprises ethylene vinyl alcohol (EVOH) and/or AlᵥOₓ and/or SiO_{y} and/or polyethylene terephthalate and/or polyamide.

12. Tube laminate film according to claim 1, wherein the barrier layer comprises polylactic acid (PLA).

13. Tube packaging having a tube body and a closure component joined thereto, in which tube packaging the tube body is formed at least partly from a tube laminate film according to claim 1.
